(19) United States
(12) Patent Application Publication
(10) Pub. No.: US 2014/0376049 A1
(43) Pub. Date: Dec. 25, 2014

(54) Direct Printing of Photos from Mobile Devices

(71) Applicant: Werner Von Stein, San Francisco, CA (US)

(72) Inventor: Werner Von Stein, San Francisco, CA (US)

(21) Appl. No.: 14/309,361

(22) Filed: Jun. 19, 2014

Related U.S. Application Data
(60) Provisional application No. 61/837,054, filed on Jun. 19, 2013.

(51) Int. Cl. G06F 3/12

(52) U.S. Cl. CPC G06F 3/1292; G06F 3/1204; G06F 3/1247
USPC 358/1.15

(57) ABSTRACT

Presented herein are methods for the facile wireless printing of photos from mobile devices. The methods are directed to the seamless printing of images via a photo server which accepts files transmitted from a mobile device and relays them to a printer. The systems and methods of the invention are especially amenable to the easy, wireless transfer of images from a mobile device to a photo printing kiosk, where a user may view and edit images, specify printer settings, and print hard copies of the image. Systems for printing at remote printers and kiosks are enabled as well.

### CROSS-REFERENCE TO RELATED APPLICATIONS

This application is based on and claims the benefit of priority of U.S. Provisional Patent Application Ser. No. 61/837,054, filed Jun. 19, 2013, the contents of which are hereby incorporated by reference in their entirety.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISK APPENDIX

Not Applicable.

### BACKGROUND AND SUMMARY OF THE INVENTION

In recent years, there has been an incredible proliferation of smartphones and other mobile devices such as tablets and pads. These hand-held devices include embedded digital cameras, and also have broadband wireless or Wi-Fi capabilities allowing for the wireless transmission and receipt of large amounts of data. The quality of digital cameras embedded within mobile devices has increased dramatically in a short time, and cameras capable of taking high-resolution photos, often aided by flash units are prevalent. Coupled with the large memory storage capacity of the devices, users are able to snap high-quality photos with great ease. Currently, it is not uncommon for users to take hundreds or even thousands of photos annually.

Electronic images are easily captured and shared. However, digital pictures cannot compare with the durability, ease of display, nostalgic value, and enjoyment of a tangible print. High-quality and fast digital printers are inexpensive and within the reach of most consumers. However, printing photos is often seen as a chore and many people do not have hard copies of their favorite images. The ability to easily and conveniently print images has not kept pace with the capacity for quickly capturing images. Accordingly, there is a need in the art for systems which aid users in printing their photos with the same ease as which they take photos.

The inventions described herein help to fulfill this unmet need in many aspects. In one aspect, the invention comprises software, and hardware/software systems that aid in the wireless transmission of digital images to a printer for facile printing. In another aspect, the invention comprises novel methods for users to send images to a printer and retrieve hard copies. In yet another aspect, the invention comprises novel business methods of using photo printer stations that employ the image transmission methods and systems described herein.

### BRIEF DESCRIPTION OF THE FIGURES

FIG. 1 is a flowchart which describes one implementation of the general process of the invention wherein file interconversion takes place. In a first step, the user selects an image to be printed (101) from the library of a mobile device. A photo server within wireless communication range is recognized by the wireless communication capabilities of the mobile device (102). The photo server communicates the destination(s) to which it is networked to the mobile device, and this destination or destinations are displayed for the user, who selects a destination for the image file (103). The image file is then converted to a print file (104). The print file transferred to the photo server (105). The photo server performs operations to extract the image data from the print file and creates a new image file (106). The new image file is routed by the server to its destination, a kiosk in this example (107). The received new image file is displayed on the kiosk screen, allowing the user to edit the image and specify print settings (108). One or more hard copies of the image are subsequently printed (109).

FIG. 2 is a flowchart which describes one implementation of the general process of the invention. In a first step, the user selects an image to be printed (201) from the library of a mobile device. A photo server within wireless communication range is recognized by the wireless communication capabilities of the mobile device (202). The photo server communicates the destination(s) to which it is networked to the mobile device, and this destination or destinations are displayed for the user, who selects a destination for the image file (203). The image file is then copied and transferred to the photo server (204). The image file is routed by the server to its destination, a kiosk in this example (205). The received image file is displayed on the kiosk screen, allowing the user to edit the image and specify print settings (206). The image is subsequently printed (207).

### DETAILED DESCRIPTION OF THE INVENTION

As used herein, “mobile device” will refer to handheld devices such as smart phones, tablets, pads, and other compact computers having wireless communication capabilities, a digital camera for capturing images, image file storage capacity, and processing means for operating the Google android operating software, iOS operating software, or any other operating system.

As used herein, “software” will refer to computer programs, i.e. computer instructions stored on a non-transitory computer readable storage medium that when executed by a machine result in a desired operation occurring. The methods of the invention are enabled and executed by the use of various software programs, comprising non-transitory computer readable storage medium carrying computer programs that will cause a suitable general purpose computer to carry out the methods described herein. It will be appreciated by one of skill in the art that these computer operations enabled by the software encompass interactions with a variety of standard processing means, data storage and retrieval means, hardware elements, user interfaces, and user inputs to effect the methods described herein and are not limited to any specific hardware or software elements.

Various aspects of the invention are directed to software which performs functions on a mobile device or photo server. In many embodiments, such software will reside and operate entirely on the mobile device or photo server. However, it will be understood that either the device or the photo server may alternatively utilize remote software and computational elements to effect the same processes, for example in thin client architectures wherein operations are performed remotely or enabled by streaming protocols, in which software elements performing functions are transmitted to the device or photo server as needed as needed. It will be understood that references to software, as used herein is not limited to a single program, and multiple separate software programs or modules may reside and operate on the device or photo server to effect the operations of the invention. In some embodiments, the device may act as an interface for operations to be carried by a remote computer. For example, in one embodiment, the software portion of the system comprises a website accessed by the mobile device via a web browser, which accesses a remote processing means for performance of the functions described herein.

As referenced herein, wireless communication will be understood to encompass any method of wireless communication between devices, including Wi-Fi, Bluetooth, and other methods of wireless communication known in the art.

As used herein, “image file” will refer to a computer data file encoding an image, for example a photograph captured by a mobile device. Image files may be stored in any number of formats, for example PNG, JPG, TIFF, GIF, BMP and other image file formats known in the art.

While the embodiments disclosed herein are described with respect to the printing of image files (i.e. pictures), it will be understood by one of skill in the art that any type of file may be transmitted and printed using the systems and methods described, for example documents such as Microsoft Word files, spreadsheets, vector art, and other printable file formats and materials.

As used herein, “kiosk” will refer to a system comprising a printer, a computer for controlling the actions of the printer, computer memory storage capacity, and, optionally, networking capability, which such system performs the kiosk functions described herein. The kiosk optionally comprises other elements such as a touchscreen, keyboard, credit card payment system, packaging equipment, and other elements for the printing, packaging, purchasing, and processing of pictures. As used herein, kiosk may refer to an integrated system or multiple components. For example, the wireless communication hardware, control software, computer memory, printer, and user interfaces (e.g. touchscreen) may reside in a single physical unit, such as a freestanding kiosk or tabletop unit. Alternatively, the kiosk functions may be performed by multiple pieces of hardware not integrated into a single physical unit. The kiosks of the invention are not limited to any specific configuration.

As used herein, “a print” or “a hard copy” will refer to an image or other printed material which has been printed onto a piece of paper (or other substrate, such as a secondary product, as described herein).

As used herein, “editing functions” encompass standard image editing tools such as cropping, framing (i.e. positioning a cropping box of preset proportions such as 5 by 7 inches, 4 by 6 inches etc.), color correction, brightness adjustment, contrast adjustment, and red-eye correction. Other editing functions include ganging, allowing the user to place, size, and organize multiple images on a single sheet (e.g. an 8.5 by 11 inch sheet). Additional editing functions include watermarking or adding captions. Editing functions may further include specifications for incorporating printed images into secondary products. For example, the user may specify a specific design and/or color of frame, mat, album, or other secondary product object into which a printed image will be incorporated or onto which the image will be printed. For example, if the finished product is an object such as a mug or a t-shirt bearing the image, editing functions allow the user to specify the color of the object, the sizing and placement of the image, etc, and these specifications become part of the edited image file.

As used herein, “secondary products” means objects which incorporate printed images, for example greeting cards, photo albums and photo books, framed and/or matted pictures, t-shirts, mugs, etc.

Herein, three different implementations of the invention are described for the purpose of illustrating the features, functions, and aspects of the invention.

### System Overview

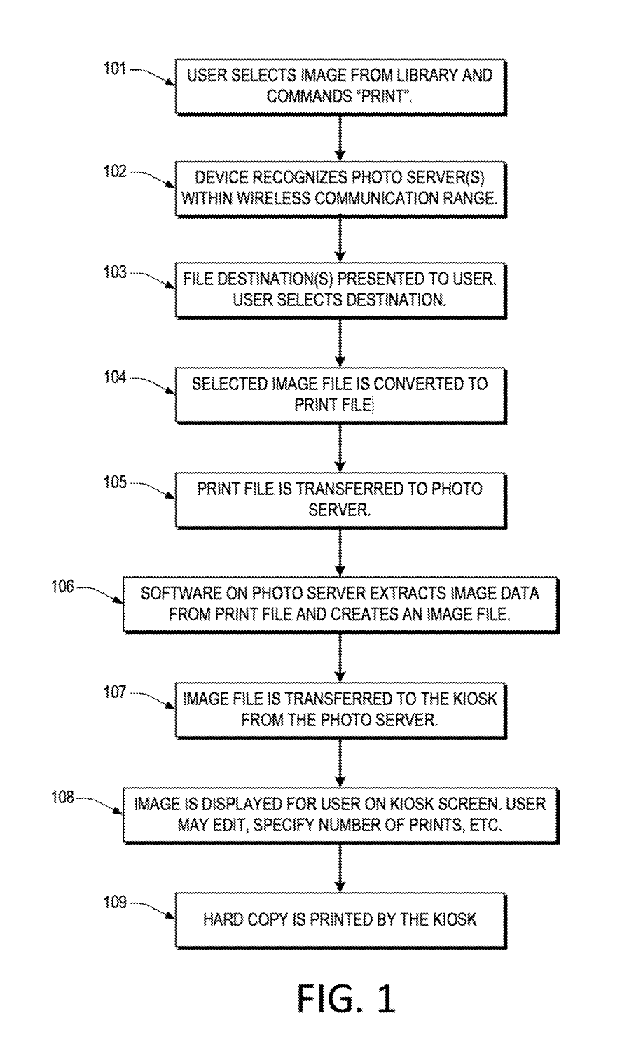

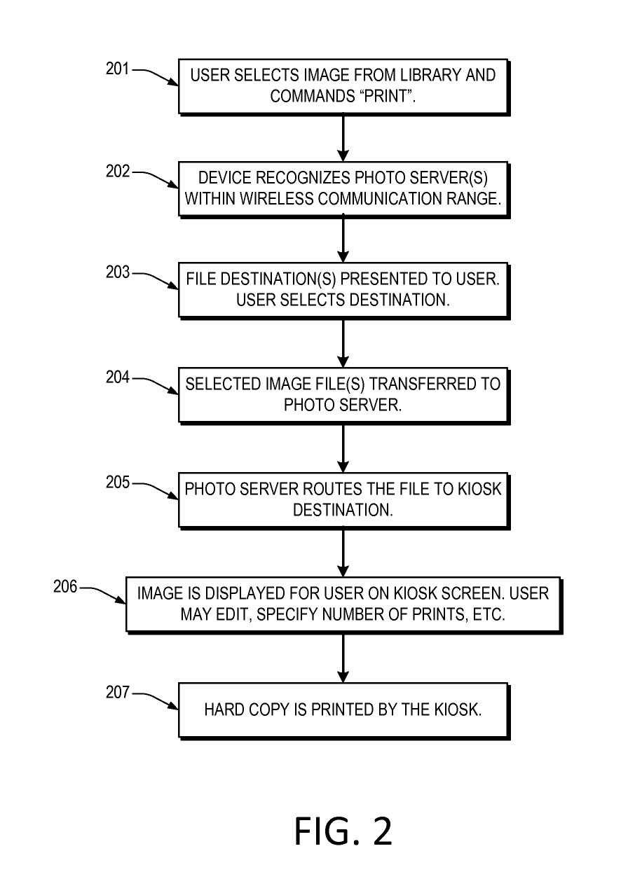

An example of the overall process of the invention is depicted in FIG. 2, and an alternative embodiment of the process of the invention is depicted in FIG. 1. The system comprises a mobile device, wherein at least one image file has been stored, e.g. a photo taken by the user. The function of the system is to transfer the image data to a kiosk, where it may be edited or printed. The transfer is enabled by a photo server, which coordinates the interaction and relays the image file between the device and the kiosk.

As used herein, “photo server” will refer to a system comprising physical hardware and software elements, including a wireless communication means, device recognition software and, optionally, image processing capabilities for effecting the operations described herein. It will be understood that the various elements of the photo server are not limited to any specific configuration, and may be arranged as an integrated unit with dedicated components (e.g., a box) or as physically separate elements and/or shared elements. In some embodiments, the photo server is a “box,” comprising a single integrated unit which contains and carries out the operations of the photo server by means of hardware elements comprising wireless communication means, and computational capabilities for effecting the image processing operations of the invention.

The photo server comprises wireless communication capabilities. In one embodiment, the photo server comprises a Wi-Fi wireless communication access point. In conjunction with the Wi-Fi hardware elements, the photo server comprises software which makes it discoverable and visible to mobile devices. Recognition of the photo server by the device may be effected by any means known in the art for wireless recognition of a peripheral device (the photo server) by a mobile device. Such recognition is typically enabled by software residing on the device and software residing on the photo server. In one embodiment, the connection between the mobile device and the photo server is facilitated by an implementation of zero configuration networking, a technology that allows seamless discovery and linking of devices. Exemplary zero configuration networking implementations include Avahi and Bonjour Service (by Apple). With the proper combination of software on a device and the photo server, the zero configuration networking enables the photo server to be discoverable by, and to communicate with the mobile device.

The photo server is also connected to a network, usually with a wired connection, but alternatively may be in wireless connection with the network. The photo server is configured to relay files to any number of destinations on the network. Each destination option is configured with a name and a unique network path where the file will be routed if that destination is selected. In one embodiment, the destination is the data storage of a kiosk. The data storage (memory) of the kiosk may be a memory means (e.g. hard disk, flash memory, etc,) residing in the kiosk, or it may be a network folder accessible by the kiosk (located in proximity to the kiosk or remotely, as desired). In one embodiment, the destination is an access server, or specific folders within an access server to which the photo server has keys and permissions necessary to deposit files there. The destination may also be a folder accessed by a printer, wherein the image file, once deposited, is fed into the print queue.

The process of the invention is initiated by the user selecting an image file for printing. For convenience, the operations of the invention will refer to the selection, transmission, printing, etc. of the process as applied to a single image file. However, it will be understood that the processes of the invention may be applied to multiple images in a batch. The image file is typically selected from the library of the mobile device where images are stored. The image file will often be an image taken by the user's digital camera. However, it is understood that image files may comprise any image files, such as photos downloaded or documents created by the user. Once the image is selected, the user initiates a print command, typically the selection of a displayed button that says “print” (as is currently typical for iOS devices) or “share” (as is currently typical for Android devices) or a like function.

Prior to, concurrent with, or subsequent to the print command, there is a recognition event. The recognition event is the discovery of a photo server by the mobile device, enabled as described above. It will be noted that in one alternative embodiment, the photo server and mobile device are directly linked by a wired connection (e.g. a USB connection). However, for convenience of the user, a wireless connection is preferred and the implementations of the invention will be described with reference to a wireless communication between the device and photo server.

Upon discovery of the photo server, the photo server will present the network destinations, to which it is configured to send files, to the device. For example, if the photo server is embedded in a single kiosk, that kiosk will be presented as a potential print or share destination to the user. In another example, if the photo server is a peripheral serving three kiosks, each kiosk is presented to the user as a destination for the image file. In another example, if the photo server is configured to route images to remote access servers or kiosks (for example, to enable remote printing, as described below), each such remote destination will be presented to the user as a destination for the image file. In one embodiment, different folders of an access server (each assigned to a separate printer or print facility) are presented as separate destinations to the user.

The user then selects the desired destination for the image file from the presented option or options. Upon this selection, in the direct implementation of FIG. 2, the image file is copied and sent to the photo server. This action may be enabled by any suitable software residing on the device. For example, for iOS devices, software residing on the device may comprise the Airprint™ (Apple) program, which allows recognition of and communication with Airprint™-enabled photo servers. In some embodiments, the software which enables recognition of the photo server by the mobile device may comprise the KioskPrint software, as described in Example 1.

In some embodiments, the photo server is configured to accept only files of a specific file format or set of formats, for example JPG, PNG, or PDF files. This aids in the security aspects of the system by preventing the downloading of malicious or other problematic file types. Such configuration protocols are known in the art. Additionally, standard anti-virus and other scanning tools may be applied to files downloaded to the photo server, as known in the art.

Upon receipt of the image file, the photo server will send it to the network destination, along the preconfigured network path for such destination.

In an alternative embodiment, as depicted in FIG. 1, the image is interconverted between file formats in its transit to the destination. In this implementation, prior to the transfer of the selected image file to the photo server, a conversion step is performed by software residing on the mobile device, e.g. a virtual printer function residing on the device. The conversion comprises the extraction of image data from the selected image file and its incorporation in a print document, for example a post-script document such as a PDF file, i.e. the image file is converted to a print file. The print file is then transmitted to the photo server via the wireless network connection between the mobile device and the photo server. The transmitted image file is stored in a data storage (memory) component of the photo server. Subsequently, software residing on the photo server effects the extraction of image data from the transferred print file. This extraction may be used to create a new image file, such as a JPEG, PNG, or other image file format version of the image that is amenable to editing and printing. For example, tools, programs, and protocol for the extraction of JPG, PNG, or other image file types from PDF files are known in the art, for example, programs such as “extractjpg” or “VeryPDF.” In some embodiments, the data storage means of the photo server is configured as a hot folder, wherein the stored images are automatically processed (e.g. converted from print files to image files, e.g. PDF to JPG) immediately upon their receipt. Upon creation of the new image file from the print file, the photo server will send it to the destination selected by the user, along the preconfigured network path for such destination.

In some embodiments, the workflow of the system for iOS devices is as depicted in FIG. 1, and the workflow of the system for Android devices is as depicted in FIG. 2.

In an alternative embodiment, the print file received by the photo server is transmitted to its destination without conversion to an image file, and image data extraction is performed subsequently. For example, the destination of the print file may be a hot folder wherein the print file is converted to an image file upon its receipt. In another embodiment, the print file is transferred to and stored at its destination, and is subsequently converted to a new image file upon selection of the file for display or printing at a kiosk.

Whether the image file has been routed directly to its destination (as in FIG. 2) or via a file interconversion step (as in FIG. 1), the remaining steps of the process are the same. In some embodiments, the destination is a folder serving a printer and the transferred image is put into the print queue. In a preferred implementation, the photo server may be connected with a kiosk, in various configurations. The user may then utilize the kiosk to effect editing, specify attributes for secondary products, and determine other print settings and may then print the images. Payment for printing services may be enabled at the device level (for example by use of an app or website interface) or at the kiosk level (by payment processing means incorporated into the kiosk, or payment of fees due to staff present at the site of the kiosk).

It is a goal of the invention to enable seamless printing of images from mobile devices. In preferred implementations, the system utilizes standard software on board each device to effect the recognition of the photo server, the conversion of image files to print files, and the transfer of converted image files to the photo server. For example, a photo server may be configured as an Airprint™-enabled peripheral in order to facilitate seamless recognition of the photo server by an iOS device and the conversion of image files to print files. Where a device or class of devices does not have onboard standard functionalities for effecting the operations of the invention, the user may download a specialized app to the device which acts to facilitate recognition of the photo server, conversion of selected image files to print files, or transfer of the converted image files to the photo server. For example, the KioskPrint app described in Example 1 may be downloaded to an Android device and will enable it to communicate with photo servers running compatible KioskPrint programs.

In those cases where a specialized app is loaded onto the device, it may be invisible or visible. In many implementations, an invisible app is preferred, wherein the recognition and file conversion functions are enabled by the app automatically without action by the user. This enables seamless and convenient printing of images by the user by simply selecting and image, entering a print command, and selecting the photo-server as the recipient of the print job.

However, in some implementations, a visible app may be utilized, for example where a separate screen is displayed to the user and the user may input various commands. For example, in one embodiment, the app provides an interface for the user to select, edit, and/or to create specifications for secondary products. The use of such an app is especially suitable for remote printing scenarios, as described below, where the user typically does not have immediate access to the kiosk.

The photo server may further comprise additional elements. For example, the photo server may comprise a network connection to the internet and a secure access means, e.g. a VPN, allowing for the remote updating of photo server software, reconfiguration of network paths for file destinations, monitoring of image transfers for billing purposes, etc.

The physical configuration of the photo server and the kiosk may vary, and is not limited to any specific implementation. Below, various exemplary configurations are described.

### Embedded Photo Servers.

The Embedded system is so called because the photo server is physically integrated with the kiosk. All the functions of the photo server, including wireless communication with mobile devices, receipt of print files from devices, and conversion of print files to image file formats, if performed, are performed by hardware and software elements residing in the kiosk, which may comprise a single table-top or freestanding unit and which has printing capabilities. The embedded system is amenable to vertically integrated proprietary systems where the enabling software and kiosks are owned and/or operated by the same party.

### Peripheral Photo Servers.

The Peripheral system is so called because the photo server is housed in a separate hardware unit (or units) which are connected to one or more kiosks but which are not physically integrated with the kiosk. In one implementation, the peripheral system comprises a box, wherein the photo server resides in a box, the box being connected to a kiosk, either by a wired or wireless connection. The Peripheral System is amenable to a “third party kiosk” system, where the owner/operator of the photo server software and hardware system can collaborate with third parties that own kiosks or have other printing capabilities. In this embodiment, the third party is supplied with the peripheral unit and can plug it into their own network. The third party does not need to install any special software on their kiosks, and does not have to install a second network card or any other capabilities into their own system. They can advantageously partner with, and access the customers of, the party that owns/operates the photo server system, while maintaining their own separate kiosk configurations/operations.

### Remote Systems.

In the prior embodiments, the user, photo server, and kiosk are typically located within the same area, for example so that the user may send image files from the device a kiosk in the immediate vicinity and operate the printing functions of the kiosk in one easy transaction. In the remote systems of the invention, the elements and operations are in one or more separate locations. The Remote system advantageously allows the user to send images to a remore print facility, for example near their home, office, or other destination where the images are printed for pickup by the user.

For example, in one remote embodiment, the photo server is located in physical proximity to the user, but the kiosk or other print facility destination is remote. In another remote embodiment, the user accesses a remote photo server by means of a generic wireless access point or wireless network (e.g. 4G). For example the images from a user's mobile device may be uploaded to a remote photo server, such as a cloud server, and the user selects a specific print facility where the selected images will be printed, such print facility having an active network connection with the cloud server. The uploaded images may then be accessed by the selected print facility, for example, being fed into the print queue and printed immediately upon receipt.

The Remote system may comprise an app, which runs on the user's mobile device and allows for selection of images to be printed and optionally allows the user to edit or input specifications for secondary products for printing at remote kiosks. In another embodiment, the app is the interface which displays the potential print destinations served by the photo server, for example in the form of a map, list, or dropdown menu.

It will be understood by one of skill in the art that the scope of the invention is not limited to the exemplary systems described herein. Variations thereof, for example, hybrid systems incorporating elements of one or more implementation fall within the scope of the invention as well. For example, a kiosk running Embedded software may also have network access and be capable of accessing image files assigned to it, such image files having been uploaded to and stored on a key server or license server as in a Remote System. A Peripheral hardware element having network access may likewise access and download images on a cloud server and assigned to it, as in Remote System.

### Improvements to Current Remote Systems.

In addition to the systems described above, various other remote printing systems are known in the art, wherein a user may transmit images from a mobile device to a central server, such images designated for subsequent printing at a remote print facility. The present invention comprises improvements to current systems, as described below.

In one embodiment, the improvement to current remote printing systems comprises a reminder function. In this implementation, the user selects a remote printing facility for printing images, transmits images from their mobile device to a central server which designates the remote printing facility for printing the images, and subsequently visits the remote printing facility to pick up the printed images. The system further comprises a reminder function, in which the GPS or location service capabilities of the mobile device are utilized, and when the user is in the proximity of the remote print facility, the user is reminded to pick up their prints. Users may further be provided with directions or other navigational aids directing them to the print facility.

In another embodiment, remote systems are directed at commuters and travelers, for example, users waiting at a bus or train station or an airport, or confined in a bus, train, or airplane. In one embodiment, remote print facilities are located at or in proximity to transit stations such as airports, subway stops, and bus stops. For example, users at a departure airport may specify that selected images be printed at their destination airport and may pick them up upon their arrival. In one embodiment, such systems further comprise advertising at transit stations, at airports, on buses, trains or airplanes, such advertising urging viewers/listeners to download the appropriate app (or access the appropriate website) and/or to utilize the remote printing system to create prints for pickup at their destination. For example, airport advertising could be directed at travelers returning home, urging them to print their vacation photos.

Time-, GPS-, or WiFi proximity-based prompts may be generated by the app so that the user is reminded to pick up their prints when they arrive or when they are in the vicinity of the print facility. For example, when the GPS or other location service function of the user's mobile device detects that the user is within proximity of the print facility, a prompt (e.g. pop-up screen, tone, text message, etc) is used to remind the user to pick up their printed images. Alternatively, the prompts could be timed to arrive at the predicted time of the user's arrival at their destination (e.g. based on timetables for buses, trains, or flights). Alternatively, prompts could be linked to transit or flight tracking systems such that the prompt is made upon the user's actual arrival at the destination containing or in proximity to the print facility.

### Example 1

### Kiosk Print Software

An exemplary implementation of the invention is software called “KioskPrint.” KioskPrint exists as two separate pieces of software, the KioskPrint app and the KioskPrint software which runs on a peripheral photo server (box). The box comprises a Wi-Fi wireless access point connected to a Raspberry Pi module. The Raspberry Pi module is network connected to up to fifteen network destinations, the network path for each being specified by the administrator of the system. KioskPrint utilizes Avahi to facilitate easy and seamless connection between mobile devices and the box. Users connecting with the photo server via a mobile device may select are provided with a list one or more printers, each associated with a specific network destination, which are displayed when the user selects a photo from the library to print and share.

If the user is utilizing an iOS device and selects an image file for transmission to the network destination, virtual printer drivers on the iOS mobile device will convert image data from of selected image files to a PDF print file and will transmit the converted file to the photo server via the iOS device's on-board Airprint software. Batch images are transmitted serially, with the photo server communicating back to the iOS devices that each file has been received, after which the following file is sent, until all files have been received. The methodology of the KioskPrint system for iOS devices is as depicted in FIG. 1.

Print files received by the photo server are converted to new image files by extraction of the image data by the KioskPrint software residing on the photo server. The new image files are then transmitted to the kiosk selected by the user kiosk via the photo server's network connection.

For Android devices, the KioskPrint app is downloaded to the mobile device to enable printing. The selected image files are copied and transmitted to the photo server directly, and are not converted to print files as with iOS devices. These received files are then transmitted to the kiosk selected by the user. The methodology of the KioskPrint system for Android devices is as depicted in FIG. 2.

Once received by the kiosk, the user is able to display image files, and by touchscreen or other interface, edit them (e.g. cropping and sizing, color correction, etc), and specify print settings (e.g. paper size, number of copies, etc). The images may then be printed by the kiosk's integral printer.

All patents, patent applications, and publications cited in this specification are herein incorporated by reference to the same extent as if each independent patent application, or publication was specifically and individually indicated to be incorporated by reference. The disclosed embodiments are presented for purposes of illustration and not limitation. While the invention has been described with reference to the described embodiments thereof, it will be appreciated by those of skill in the art that modifications can be made to the structure and elements of the invention without departing from the spirit and scope of the invention as a whole.

1. A system for the printing of images from a mobile device comprising
a mobile device, comprising wireless communication capabilities and library wherein one or more digital image files are stored;
a photo server, comprising wireless communication capabilities which enable it to be discovered by the mobile device, and network capabilities, wherein the photo server is configured via its network capabilities to transfer files to one or more network destinations; and
a printer, wherein the print jobs are accessed from the one or more network destinations.

2. The system of claim 1, wherein communication between the mobile device and the photo server is enabled by an implementation of zero-configuration networking.

3. The system of claim 2, wherein the zero-configuration networking protocol is Avahi or Bonjour Service.

4. The system of claim 1, wherein the network destination is a folder accessible by a photo-printing kiosk, the kiosk comprising a means of displaying images, allowing users to specify print settings, and a printer.

5. The system of claim 5, wherein the kiosk further comprises a means of collecting payment for printing services.

6. The system of claim 1, further comprising
software on the mobile device which converts a selected image file to a print file prior to its transmission to the photo server; and
software on the photo server which extracts image data from a received print files and converts it to an image file.

7. The system of claim 1, wherein
the photo server is integrated with a photo printing kiosk.

8. The system of claim 1, wherein
the photo server is housed in a peripheral body and is connected to one or more photo printing kiosks.

9. The system of claim 1, wherein
the photo server sends images received from the mobile device to a network folder which is accessed by a remote printer.

10. A method of printing an image from a mobile device, comprising the steps of
selecting an image file from the image file library of the mobile device;
establishing communication between the mobile device and a photo server located within wireless communication range of the mobile device, wherein the photo server transmits a list of one or more network destinations to the mobile device, the one or more network destinations being associated with a printer and being displayed for the user;
upon the user's selection of network destination, the selected image file is copied and transmitted by the mobile device to the photo server;
upon the receipt of the image file by the photo server, the image is transmitted to the selected network destination; and
upon receipt of the image file by the network destination, the image file may be accessed by a printer; and
a hard copy of the image file is printed by the printer.

11. The method of claim 10, wherein the network destination is a folder accessible by a photo printing kiosk, and prior to printing, the image file received by the folder is displayed for a user to perform editing or print settings.

12. The method of claim 10, wherein the photo server is integrated within a photo printing kiosk.

13. The method of claim 10, wherein the photo server is housed in a peripheral body and is connected to one or more photo printing kiosks.

14. The method of claim 10, wherein the printer is remote from the photo server.

15. The method of claim 10, wherein the photo server is configured to only accept files of a specific file format.

16. The method of claim 15, wherein the photo server is configured only to accept JPG or PDF files.
